(19) United States
(12) Patent Application Publication
(10) Pub. No.: US 2010/0169812 A1
(43) Pub. Date: Jul. 1, 2010

(54) Apparatus and method for providing widget service in portable terminal

(75) Inventor: Jong-Chul Park, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/655,386

(22) Filed: Dec. 30, 2009

(30) Foreign Application Priority Data
Dec. 30, 2008 (KR) 10-2008-0136302

(51) Int. Cl. G06F 3/048; G06F 9/44

(52) U.S. Cl. 715/764; 719/328

(57) ABSTRACT

A portable terminal includes an apparatus for enhancing security by preventing the control on an internal function of the portable terminal via a widget downloaded from a sharing site. The apparatus includes a widget engine for determining, when a widget in operation controls an internal function of the terminal, whether the widget is authorized to control the internal function, permitting the internal function control to the widget authorized to control the internal function, and blocking a widget prohibited from controlling the internal function, from controlling the internal function.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Dec. 30, 2008 and assigned Serial No. 10-2008-0136302, the entire disclosure of which is hereby incorporated by reference.

### TECHNICAL FIELD OF THE INVENTION

The present invention relates generally to an apparatus and a method for controlling a widget of a portable terminal. More particularly, the present invention relates to an apparatus and a method for enhancing security of a portable terminal by preventing the control on an internal function of the portable terminal by use of a widget downloaded from a sharing site.

That is, the present invention relates to an apparatus and a method for preventing a sharing widget downloaded from a widget sharing site from leaking personal information without user consent of a portable terminal or from using a network function such as file download/upload without permission.

### BACKGROUND OF THE INVENTION

Recently, according to the rapid advance of portable terminals, the portable terminals are used by people of both sexes and all ages as a necessity in the modern life; and used as a medium for wireless voice telephony and information exchange.

In the early spread of the portable terminal, people just recognized that it is the portable medium for allowing the wireless phone call. As the technique of the portable terminal advances, service providers and terminal manufacturers are competitively developing products (or services) for the sake of the differentiation from other providers.

For example, the portable terminal advances to a multimedia device enabling phone book, game, short message, e-mail, morning call, MP3, schedule management function, digital camera, and wireless internet service and thus provides various services.

Additionally, as the Web 2.0 technology is generalized in the recent portable terminals, a widget that offers additional functions in a personal computer is applied to the portable terminal.

The widget is serviced from a mobile communication provider, and a user of the portable terminal can put the widget on a screen of the portable terminal. For example, a puppy can run around in the screen of the portable terminal or a weather report can be obtained in advance from a weather widget.

Such a widget is designed by a corresponding service engineer and downloaded over a wired or wireless network. Lately, general users begin to design the widgets and share the designed widgets.

According to the intention of the designer, the widget is likely to send data inside the portable terminal to the outside and to control the internal functions of the portable terminal.

For instance, when the widget designed by the individual is downloaded from the sharing site and applied to the portable terminal, personal information can be leaked through the widget without recognition by the user that this has occurred.

In this respect, an apparatus and a method for restricting the internal function access of the portable terminal via the widget are demanded.

### SUMMARY OF THE INVENTION

To address the above-discussed deficiencies of the prior art, it is a primary aspect of the present invention to solve at least the above mentioned problems and/or disadvantages and to provide at least the advantages described below. Accordingly, an aspect of the present invention is to provide an apparatus and a method for enhancing security of a widget service in a portable terminal.

Another aspect of the present invention is to provide an apparatus and a method for preventing internal function control via a widget in a portable terminal.

Yet another aspect of the present invention is to provide an apparatus and a method for verifying widget information permitted to control internal functions in a portable terminal.

In accordance with an aspect of the present invention, an apparatus for providing a widget service in a portable terminal includes a widget engine for determining, when a widget in operation controls an internal function of the terminal, whether the widget is authorized to control the internal function, permitting the internal function control to the widget authorized to control the internal function, and blocking a widget prohibited from controlling the internal function, from controlling the internal function.

In accordance with another aspect of the present invention, a method for providing a widget service in a portable terminal includes determining whether a widget in operation is to control an internal function of the terminal; when determining the widget intending to control the internal function, determining whether the widget in operation is authorized to control the internal function; when the widget is authorized to control the internal function, permitting the internal function control; and when the widget is forbidden to control the internal function, blocking from controlling the internal function.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a portable terminal according to an exemplary embodiment of the present invention;

FIG. 2 illustrates a flowchart of a method for generating a profile for a widget indicative of control permission or disapproval in the portable terminal according to an exemplary embodiment of the present invention;

FIG. 3 illustrates a flowchart of a method for operating the widget in the portable terminal according to an exemplary embodiment of the present invention; and

FIG. 4 illustrates a flowchart of a method for operating the widget in the portable terminal according to an exemplary embodiment of the present invention.

Throughout the drawings, like reference numerals will be understood to refer to like parts, components and structures.

### DETAILED DESCRIPTION OF THE INVENTION

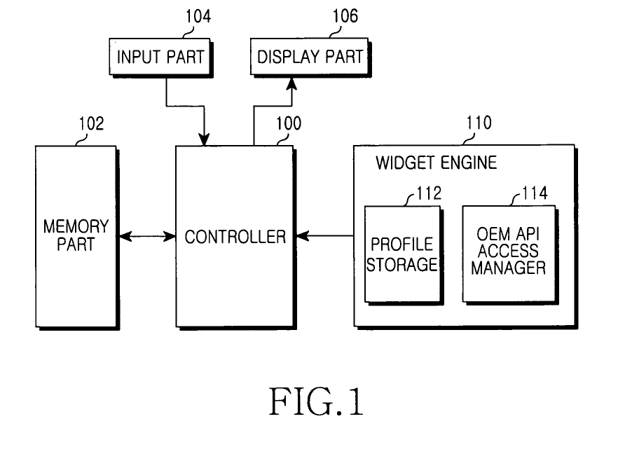

FIGS. 1 through 4, discussed below, and the various embodiments used to describe the principles of the present disclosure in this patent document are by way of illustration only and should not be construed in any way to limit the scope of the disclosure.

Exemplary embodiments of the present invention provide an apparatus and a method for controlling an internal function merely using a corresponding widget by determining a widget permitted to control the internal function of a portable terminal in order to enhance security of a widget service in the portable terminal.

FIG. 1 illustrates a block diagram of a portable terminal according to an exemplary embodiment of the present invention.

The portable terminal of FIG. 1 includes a controller 100, a memory part 102, an input part 104, a display part 106, and a widget engine 110. The widget engine 110 may include a profile storage 112 and an OEM API access manager 114.

The controller 100 of the portable terminal controls operations of the portable terminal, for example, processes and controls voice communication and data communication and operates a widget downloaded by a user of the portable terminal. The controller 100 controls the widget engine 110 to prevent the function control access of the portable terminal with respect to the widget downloaded by the user of the portable terminal. In other words, the controller 100 permits the function control access only to the allowed widget.

The controller 100 generates a profile including widget information permitting or blocking the function control access of the portable terminal. When detecting that the operating widget accesses the function control of the portable terminal, the controller 100 determines whether the widget is allowed to the function control access by determining the profile. Next, the portable terminal may permit or block the function control access of the operating widget.

The controller 100 may manage the function control via the corresponding widget by differentiating the controllable functions on the widget basis.

The memory part 102 may include a ROM, a RAM, and a flash ROM. The ROM stores microcodes of programs for the processing and the controlling of the controller 100, and various reference data.

The RAM, which is a working memory of the controller 100, stores temporary data generating in the program executions. The flash ROM contains various updatable storage data such as phone book, sending messages, received messages and the like.

The input part 104 includes a plurality of function keys such as numeric key buttons 0˜9, menu button, cancel button (delete), OK button, call button, end button, Internet access button, navigation key (or direction key) buttons, character input keys and the like. The input part 104 provides the controller 100 with key input data (e.g., widget execution request) corresponding to the key pressed by the user. The input part 104 includes a touch input part for detecting touch input, and senses and provides the user's touch input to the controller 100.

The display part 106 displays status information, a limited number of characters, videos, and still images generating in the operations of the portable terminal. The display part 106 may employ a color Liquid Crystal Display (LCD) device.

The widget engine 110 includes the profile storage 112 and the OEM API access manager 114 as stated earlier, and controls the operation of the widget downloaded by the user of the portable terminal.

The profile storage 112 of the widget engine 110 stores the profile generated by the controller 100, that is, the profile including the information of the widget that permits or blocks the function control access of the portable terminal.

When the widget accesses to the OEM API that controls the internal function of the portable terminal, the OEM API access manager 114 of the widget engine 110 determines whether the widget is permitted or forbidden to control the function of the portable terminal, by examining information of the widget registered to the profile stored to the profile storage 112.

While the controller 100 of the portable terminal may function as the widget engine 110, they are separately illustrated by way of example, not to limit the scope of the invention. One skilled in the art will appreciate that various modifications can be made without departing from the spirit and scope of the invention. For example, the controller 100 may process all of the functions of the widget engine 110.

So far, the apparatus for controlling the internal function only via the corresponding widget by determining the widget permitted to control the internal function of the portable terminal to thus enhance the security of the widget service in the portable terminal has been explained. Now, a method for controlling the internal function only via the corresponding widget by determining the widget permitted to control the internal function of the portable terminal to thus enhance the security of the widget service using the apparatus is described.

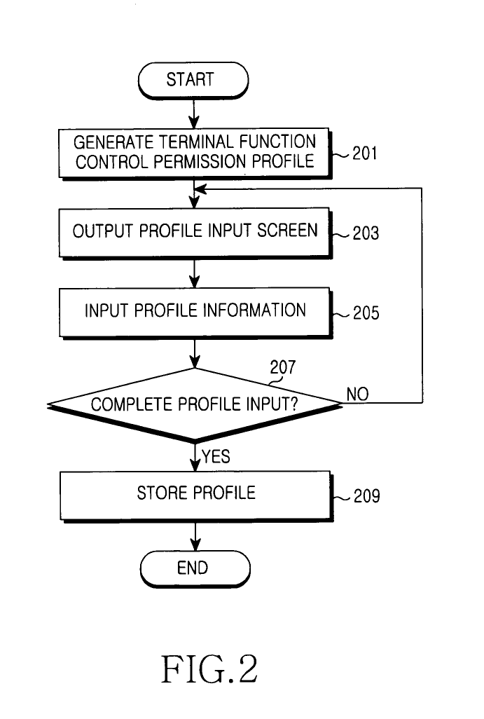

FIG. 2 illustrates a flowchart of a method for generating the profile for the widget indicative of the control permission or disapproval in the portable terminal according to an exemplary embodiment of the present invention.

The terminal generates the profile indicative of the permission or the disapproval on the terminal function control in step 201, and outputs the profile input screen in step 203.

Herein, the profile generation sets the information of the widget for permitting the function control of the portable terminal and the information of the widget for forbidding the function control of the portable terminal so as to prevent the control of the personal data inside the portable terminal via the widget. The profile input screen can include an access permission item which permits the widget, which is not authorized but is usable, to access the terminal control without limitation by setting merely a widget ID; an upload limiting and download limiting item that restricts the upload and the download of particular data; an item which restricts message delivery and telephone connection access; and an item which restricts the access to the internal data (e.g., address book, schedule, and call log) of the portable terminal.

Next, the portable terminal generates the profile by receiving profile information from the user in step 205 and determines whether the profile input is completed in step 207.

When not detecting the completion of the profile input in step 207, the portable terminal repeats the step 203.

When detecting the profile input completion in step 207, the portable terminal stores the generated profile in step 209 and then finishes this process.

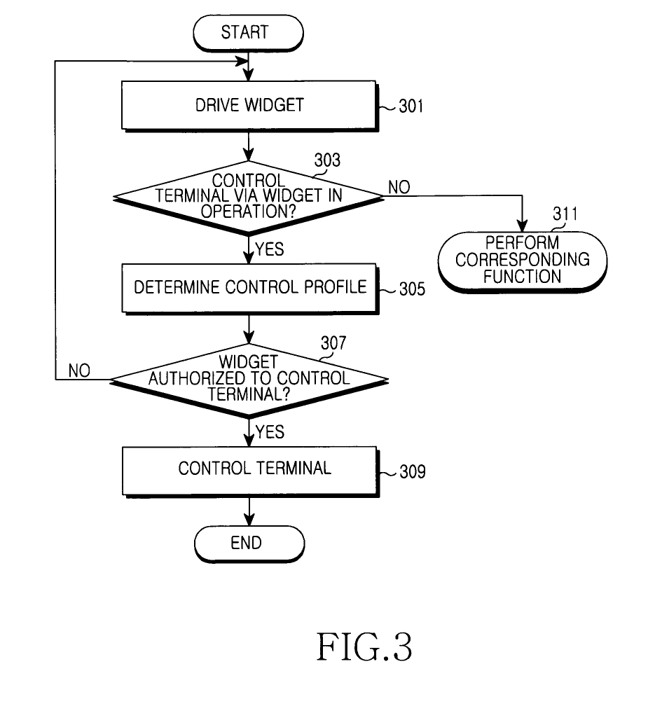

FIG. 3 illustrates a flowchart of a method for operating the widget in the portable terminal according to an exemplary embodiment of the present invention.

In step 301, the portable terminal drives the widget.

In step 303, the portable terminal determines whether the terminal is to be controlled via the widget in operation.

Herein, the controlling of the terminal via the widget indicates the attempt to read or write data in the address book, the attempt to reading or write schedule data, and the attempt to make the telephone call or send a message through a function that can control the terminal internal function using the widget.

When not detecting the control of the terminal using the widget in step 303, the portable terminal performs a corresponding function (e.g., operates the widget) in step 311.

By contrast, when detecting the control of the terminal using the widget in step 303, the portable terminal determines the control profile in step 305 and determines whether the widget is authorized for the terminal control in step 307.

Upon determining that the widget is not authorized to control the terminal in step 307, the portable terminal goes to step 301 and processes to block the terminal control.

Upon determining that the widget is authorized to control the terminal in step 307, the portable terminal processes to control the terminal in step 309.

Next, the portable terminal finishes this process.

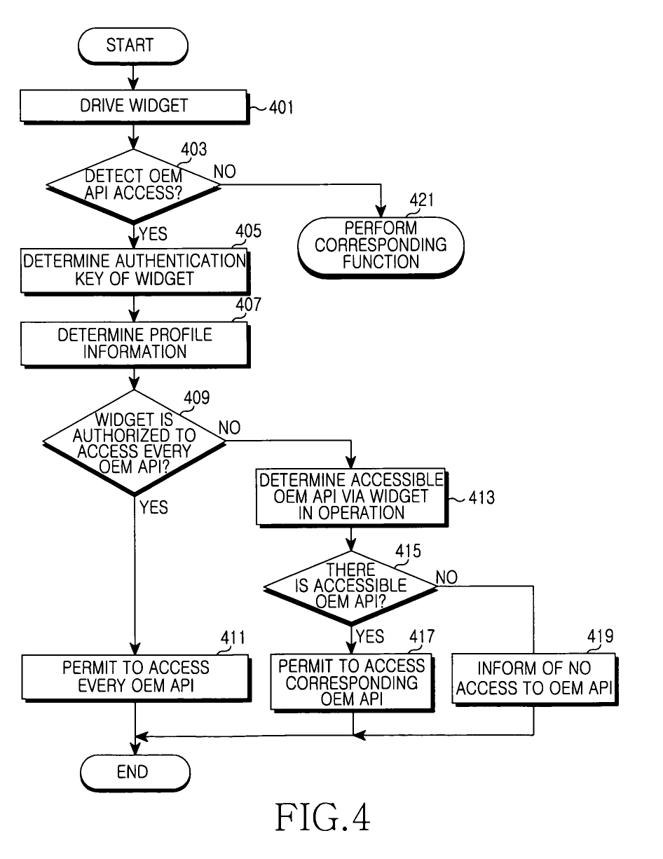

FIG. 4 illustrates a flowchart of a method for operating the widget in the portable terminal according to an exemplary embodiment of the present invention.

In step 401, the portable terminal drives the widget.

In step 403, the portable terminal determines whether the widget in operation accesses the OEM API, which is the function for controlling the internal function of the portable terminal.

Herein, the OEM API includes an OEM API for attempting to read or write data in the address book, an OEM API for attempting to read or write schedule data, and a telephone calling or message delivery OEM API.

Not detecting the access of the widget to the OEM API in step 403, the portable terminal performs a corresponding function (e.g., operates the widget) in step 421.

Upon detecting the access of the widget to the OEM API in step 403, the portable terminal determines an authentication key of the widget by decoding an authentication key value in the XML of the widget in step 405.

Next, the portable terminal determines the pre-stored profile information in step 407 and determines whether the widget is permitted to access every OEM API in step 409.

When determining that the widget is permitted to access every OEM API in step 409, the portable terminal processes to allow the access to every OEM API in step 411.

By contrast, when determining that the widget is not permitted to access every OEM API in step 409, the portable terminal determines OEM APIs accessible by the widget in operation in step 413 and determines whether there exists the OEM API accessible via the widget in step 415 and then blocks the access to the OEM API.

When determining that there is no the OEM API accessible via the widget in step 415, the portable terminal outputs a message informing of the inaccessibility to the OEM API in step 419.

When determining that there is the OEM API accessible via the widget in step 415, the portable terminal permits the access only to the corresponding OEM API in step 417.

Next, the portable terminal finishes this process.

As set forth above, the present invention provides the apparatus and the method for enhancing the security of the widget service in the portable terminal. The authority to control the internal function is granted only to the widget permitted to control the internal function of the portable terminal and the unauthorized widget downloaded from the sharing site is prevented from controlling the internal function of the portable terminal, to thus enhance the security.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for providing a widget service in a portable terminal, the apparatus comprising:
a widget engine configured to determine, when a widget in operation controls an internal function of the terminal, whether the widget is authorized to control the internal function, permit the internal function control to the widget authorized to control the internal function, and block a widget prohibited from controlling the internal function.

2. The apparatus of claim 1, wherein, when the widget is prohibited from controlling the internal function, the widget engine is configured to permit to control only the function by determining the internal function control permitted to the widget.

3. The apparatus of claim 1, wherein the widget engine is configured to determine whether the widget in operation is to control the internal function of the terminal by determining whether the widget in operation accesses an OEM API that is a function configured to control the internal function of the portable terminal.

4. The apparatus of claim 3, wherein the OEM API that is the function configured to control the internal function of the portable terminal comprises at least one of:
an OEM API configured to attempt to read or write data in an address book;
an OEM API configured to attempt to read or write data of schedule; and
one of a telephone calling and a message sending OEM API.

5. The apparatus of claim 1, wherein the widget engine is configured to determine whether the widget is authorized to control the internal function by comparing a profile comprising at least one of information of the widget permitted to control the internal function with information of the widget in operation; and forbidden to control the internal function with information of the widget in operation.

6. The apparatus of claim 5, wherein the widget engine is configured to examine the information of the widget in operation by decoding an authentication key value in an XML of the widget.

7. The apparatus of claim 1, wherein the widget engine is configured to generate the profile by one of:
using information set by a user of the portable terminal; and
using preset information.

8. The apparatus of claim 7, wherein the profile comprises at least one of information of the widget authorized to control the internal function, controllable functions per widget, and an upload and download limiting item.

9. A method for providing a widget service in a portable terminal, the method comprising:
determining whether a widget in operation is to control an internal function of the terminal;
determining whether the widget in operation is authorized to control the internal function when determining the widget intending to control the internal function;
permitting the internal function control when the widget is authorized to control the internal function; and
blocking from controlling the internal function when the widget is forbidden to control the internal function.

10. The method of claim 9, further comprising:
determining the internal function control permitted to the widget when the widget is prohibited from controlling the internal function; and
permitting to control the determined internal function.

11. The method of claim 9, wherein the determining of whether the widget in operation is to control the internal function of the terminal determines whether the widget in operation accesses an OEM API that is a function for controlling the internal function of the portable terminal.

12. The method of claim 11, wherein the OEM API that is the function for controlling the internal function of the portable terminal comprises at least one of an OEM API for attempting to read or write data in an address book, an OEM API for attempting to read or write data of schedule, and a telephone calling or message sending OEM API.

13. The method of claim 9, wherein the determining of whether the widget is authorized to control the internal function comprises:
examining a profile comprising information of the widget permitted or forbidden to control the internal function; and
comparing widget information of the profile with information of the widget in operation.

14. The method of claim 13, wherein the information of the widget in operation is examined by decoding an authentication key value in an XML of the widget.

15. The method of claim 9, wherein the profile is generated using information set by a user of the portable terminal or using preset information.

16. The method of claim 15, wherein the profile comprises at least one of information of the widget authorized to control the internal function, controllable functions per widget, and an upload and download limiting item.

17. A portable terminal capable of providing a widget service, the portable terminal comprising:
a widget engine configured to determine, when a widget in operation controls an internal function of the terminal, whether the widget is authorized to control the internal function, permit the internal function control to the widget authorized to control the internal function, and block a widget prohibited from controlling the internal function.

18. The portable terminal of claim 17, wherein, when the widget is prohibited from controlling the internal function, the widget engine is configured to permit to control only the function by determining the internal function control permitted to the widget.

19. The portable terminal of claim 17, wherein the widget engine is configured to determine whether the widget in operation is to control the internal function of the terminal by determining whether the widget in operation accesses an OEM API that is a function configured to control the internal function of the portable terminal.

20. The portable terminal of claim 19, wherein the OEM API that is the function configured to control the internal function of the portable terminal comprises at least one of:
an OEM API configured to attempt to read or write data in an address book;
an OEM API configured to attempt to read or write data of schedule; and
one of a telephone calling and a message sending OEM API.

21. The portable terminal of claim 17, wherein the widget engine is configured to determine whether the widget is authorized to control the internal function by comparing a profile comprising at least one of information of the widget permitted to control the internal function with information of the widget in operation; and forbidden to control the internal function with information of the widget in operation.

22. The portable terminal of claim 21, wherein the widget engine is configured to examine the information of the widget in operation by decoding an authentication key value in an XML of the widget.

23. The portable terminal of claim 17, wherein the widget engine is configured to generate the profile by one of:
using information set by a user of the portable terminal; and
using preset information.

24. The portable terminal of claim 23, wherein the profile comprises at least one of information of the widget authorized to control the internal function, controllable functions per widget, and an upload and download limiting item.
